(19) United States
(12) Patent Application Publication
(10) Pub. No.: US 2016/0273630 A1
(43) Pub. Date: Sep. 22, 2016

(54) BRAKE OPERATING DEVICE

(71) Applicant: TOYOTA JIDOSHA KABUSHIKI KAISHA, Toyota-shi (JP)

(72) Inventor: Takahiro OGAWA, Okazaki-shi (JP)

(73) Assignee: TOYOTA JIDOSHA KABUSHIKI KAISHA, Toyota-shi (JP)

(21) Appl. No.: 15/051,040

(22) Filed: Feb. 23, 2016

(30) Foreign Application Priority Data
Mar. 17, 2015 (JP) 2015-053664
Nov. 18, 2015 (JP) 2015-225647

(51) Int. Cl. F16H 21/44; B60T 7/06

(52) U.S. Cl. CPC F16H 21/44; B60T 7/06

(57) ABSTRACT

A brake operating device includes: a brake operating member configured to be operated and moved forward; a first spring configured to be extended with forward movement of the brake operating member to urge the brake operating member in a direction in which the brake operating member is moved backward; and a second spring configured to be compressed with forward movement of the brake operating member to urge the brake operating member in the direction in which the brake operating member is moved backward. The second spring is configured to buckle when the brake operating member is moved by greater than or equal to a predetermined amount.

### CROSS REFERENCE TO RELATED APPLICATION

The present application claims priority from Japanese Patent Application Nos. 2015-053664 filed on Mar. 17, 2015, and 2015-225647 filed on Nov. 18, 2015, the disclosures of which are herein incorporated by reference.

### BACKGROUND

1. Technical Field

The present invention relates to a brake operating device for a vehicle, to which a braking operation of a driver is input.

2. Description of the Related Art

A brake operating device includes a brake operating member and a return spring for returning the brake operating member operated by a driver to its original position and for applying a reaction force against a braking operation of the driver. Patent Document 1 discloses return springs including; a return spring which is provided in front of a brake pedal as a brake operating member and extended with depression of the brake pedal to directly urge the brake pedal in a direction in which the brake pedal is returned to its original position; and a return spring provided in a master cylinder to indirectly urge the brake pedal in the direction in which the brake pedal is returned to its original position.

### PRIOR ART DOCUMENT

### Patent Document

### Patent Document 1: WO2010/055842

### SUMMARY

In order to generate a feeling of stiffness as an operation feeling of a braking operation at initial brake input to a brake operating member, a relatively large reaction force is preferably applied against the braking operation during an initial stroke within a range of stroke of an operation of the brake operating member. In contrast, in the case where the brake operating member is operated by a large amount in, e.g., sudden braking, a reaction force against the braking operation is preferably small to generate a large braking force. In a braking device disclosed in Patent Document 1, for example, these two situations are dealt with by changing a combination of use depending upon an operating amount of the brake operating member among components and devices such as the above-described return springs and a stroke simulator. However, a plurality of return springs such as springs in the master cylinder are used in combination in parallel or in series, resulting in complicated construction. That is, it is considered that dealing with the above-described situations with a simple construction improves utility of a brake operating device. Accordingly, an aspect of the disclosure relates to a practically effective brake operating device.

In one aspect of the disclosure, a brake operating device comprises:

a first spring configured to be extended with forward movement of a brake operating member to urge the brake operating member in a direction in which the brake operating member is moved backward; and

a second spring configured to be compressed with forward movement of the brake operating member to urge the brake operating member in the direction in which the brake operating member is moved backward,

the second spring configured to buckle when the brake operating member is moved by greater than or equal to a predetermined amount.

### Effects

In this brake operating device, in the case where a braking operation is performed with increase in the operating amount of the brake operating member, the second spring buckles in the middle of the operation, and accordingly increase in a reaction force is reduced against a braking operation for further increasing the operating amount of the brake operating member. That is, in the brake operating device, a feeling of stiffness is generated by application of a relatively large reaction force at initial brake input to the brake operating member, and in the case where the brake operating member is operated by a large amount in, e.g., sudden braking, a large braking force can be generated. Thus, the brake operating device can achieve these effects with simple construction, and accordingly the brake operating device is practically effective.

### FORMS OF THE INVENTION

There will be described various forms of the invention which is considered claimable (hereinafter referred to as “claimable invention” where appropriate). Each of the forms of the invention is numbered like the appended claims and depends from the other form or forms, where appropriate. This is for easier understanding of the claimable invention, and it is to be understood that combinations of constituent elements that constitute the invention are not limited to those described in the following forms. That is, it is to be understood that the claimable invention shall be construed in the light of the following descriptions of the various forms and the embodiments. It is to be further understood that any form in which one or more elements is/are added to or deleted from any one of the following forms may be considered as one form of the claimable invention.

(1) A brake operating device, comprising:

a brake operating member configured to be operated by a driver and moved forward;

a first spring configured to be extended with forward movement of the brake operating member to urge the brake operating member in a direction in which the brake operating member is moved backward; and

a second spring configured to be compressed with forward movement of the brake operating member to urge the brake operating member in the direction in which the brake operating member is moved backward,

the second spring configured to buckle when the brake operating member is moved by greater than or equal to a predetermined amount.

In the brake operating device according to this form, in the case where a braking operation is performed with increase in the operating amount of the brake operating member, the second spring buckles in the middle of the operation. When the buckling of the second spring occurs, a reaction force generated by the second spring increases by a smaller amount, substantially ceases increasing, or becomes smaller than a reaction force at the point in time of the occurrence of the buckling, in response to a braking operation for further increasing the operating amount from the point in time of the occurrence of the buckling of the second spring. Thus, an amount of increase in reaction force by the first spring and the second spring in response to the braking operation for further increasing the operating amount can be made smaller after the occurrence of the buckling of the second spring than before the occurrence of the buckling. That is, in the brake operating device according to this form, the two springs can apply a relatively large reaction force at initial brake input to the brake operating member to generate a feeling of stiffness. In the case where the operation amount of the brake operating member increases due to, sudden braking, the increase in the reaction force decreases with the increase in the operating amount. Accordingly, the braking operation amount easily increases, enabling generation of a large braking force.

The brake operating device according to this form may be a device for which a braking operation is performed with a foot of a driver, i.e., a device including a brake pedal as the brake operating member. Also, the brake operating device according to this form may be a device which is operated by a hand of the driver, i.e., a device provided with a brake lever as the brake operating member.

(2) The brake operating device according to the above form (1),

wherein the brake operating member is a brake pedal comprising a lower end portion provided with a depressing portion,

wherein the brake operating device comprises a pedal support configured to support the brake pedal at an upper portion of the brake pedal such that the brake pedal is pivotable, and

wherein the second spring is configured to buckle when the brake pedal is depressed by greater than or equal to a predetermined angle.

The brake operating device according to this form is limited to an operating device for performing a braking operation using foot power of the driver.

(3) The brake operating device according to the above form (2), wherein the first spring is provided between the brake pedal and a rear portion of the pedal support, and

wherein the second spring is provided between the brake pedal and a front portion of the pedal support.

In the brake operating device according to this form, the brake pedal and the two return springs are provided as a unit, enabling the unit to be easily mounted on a vehicle body.

(4) The brake operating device according to any one of the above forms (1) through (3), wherein a spring constant of the second spring before buckling of the second spring is greater than a spring constant of the first spring.

In the brake operating device according to this form, a spring constant of the overall device after an occurrence of the buckling of the second spring can be made less than or equal to half a spring constant of the overall device before the buckling. That is, the larger a difference between the spring constant of the second spring and the spring constant of the first spring is made, the smaller an increase in a reaction force acting on the braking operation after the occurrence of the buckling of the second spring can be made.

(5) The brake operating device according to any one of the above forms (1) through (4),

wherein the first spring and the second spring are configured to urge the brake operating member by a total force in the direction in which the brake operating member is moved backward, and

wherein an amount of increase in the total force with respect to a distance of forward movement of the brake operating member is less after an occurrence of buckling of the second spring than before the occurrence of the buckling of the second spring.

In the brake operating device according to this form, the sum of the spring constant of the first spring and the spring constant of the second spring is less after the occurrence of buckling of the second spring than before the occurrence of the buckling of the second spring. In the present form, the reaction force against the braking operation increases also after the occurrence of the buckling of the second spring, making it possible to provide an operation feeling for the driver.

(6) The brake operating device according to any one of the above forms (1) through (5), wherein the second spring is configured such that a force of the second spring for urging the brake operating member in the direction in which the brake operating member is moved backward does not increase even when the brake operating member is further moved forward by the second spring after an occurrence of buckling of the second spring.

In the brake operating device according to this form, only the reaction force generated by the first spring increases after the occurrence of the buckling of the second spring without increase in the reaction force generated in the second spring. Accordingly, the brake operating device according to this form is preferable from the viewpoint of facilitating increase in the operation amount of the brake operating member to reliably generate a large braking force.

(7) The brake operating device according to any one of the above forms (1) through (6), wherein the second spring is a compression coil spring comprising a front portion, a rear portion, and an intermediate portion between the front portion and the rear portion and shaped such that a straight line connecting between the front portion and the rear portion and an axis of the intermediate portion are displaced from each other.

The brake operating device according to this form is a device constructed by providing a limitation to the shape of the second spring. In the brake operating device according to this form, the intermediate portion is offset from a straight line connecting opposite ends of the second spring to each other, facilitating the buckling of the second spring at its portions respectively connecting between the intermediate portion and one of opposite end portions of the second spring and connecting between the intermediate portion and the other of opposite end portions of the second spring.

### BRIEF DESCRIPTION OF THE DRAWINGS

The objects, features, advantages, and technical and industrial significance of the present disclosure will be better understood by reading the following detailed description of the embodiment, when considered in connection with the accompanying drawings, in which:

FIG. 1 is a side view illustrating a brake operating device according to one embodiment of the claimable invention;

FIG. 2 is a side elevational view in cross section illustrating a second return spring illustrated in FIG. 1;

FIGS. 3A and 3B are side elevational views of the second return spring in its compressed state;

FIG. 4 is a view illustrating a relationship between a braking operation amount and an operation reaction force in the present embodiment; and

FIG. 5 is a view illustrating a relationship between foot power applied to a brake operating member and deceleration of a vehicle equipped with the brake operating device according to the present embodiment.

### DETAILED DESCRIPTION OF THE EMBODIMENTS

Hereinafter, there will be described one embodiment by reference to the drawings. It is to be understood that the following embodiment is described only by way of example, and the disclosure may be otherwise embodied with various modifications without departing from the scope and spirit of the disclosure.

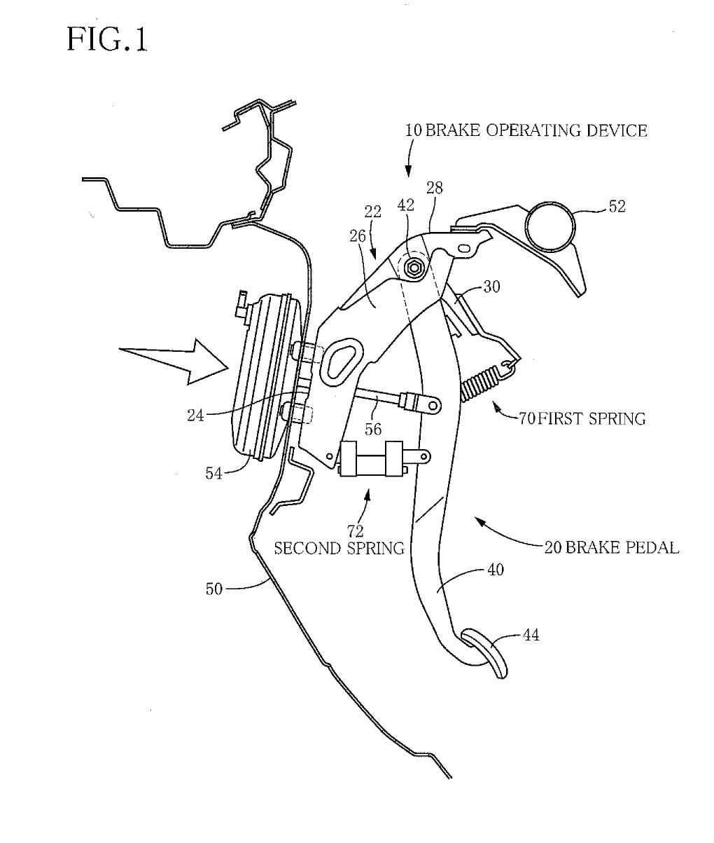

FIG. 1 illustrates a brake operating device 10 according to one embodiment of the claimable invention. This brake operating device 10 is an operating portion of a braking device and uses foot power of a driver to perform a braking operation. The brake operating device 10 includes: a brake pedal 20 (hereinafter may be simply referred to as “pedal 20”) as a brake operating member; and a pedal support 22 for supporting the brake pedal 20. That is, the brake operating device 10 is what is called a hanging operating device. The pedal support 22 includes: a base 24 serving as a foundation for mounting of the pedal support 22 on a vehicle body; a pair of side plates 26 extending in parallel from the base 24 toward the rear side of the vehicle; a top plate 28 connecting between upper edges of the respective side plates 26; and a bracket 30 extending downward from rear portions of the pair of side plates 26. The pedal 20 is pivotably supported by a rotation shaft 42 at an upper end portion of an arm 40 extending generally in an up and down direction. The rotation shaft 42 is provided in a state in which the rotation shaft 42 extends through the pair of side plates 26 of the pedal support 22. A pedal pad 44 as a depressing portion is provided on a lower end portion of the arm 40. The foot power of the driver is applied from the pedal pad 44 to swing the pedal 20 in a front and rear direction or a longitudinal direction of the vehicle.

The brake operating device 10 is mounted on the vehicle body at the pedal support 22. Specifically, a dash panel 50 is provided as a partition between an engine compartment and a passenger compartment in the vehicle, and the pedal support 22 is fixed at the base 24 to a portion of the dash panel 50 which is located on a passenger-compartment side thereof. The pedal support 22 is fixed to an instrument panel reinforcement 52 at a rear end portion of the top plate 28. The instrument panel reinforcement 52 is a beam member having opposite end portions in the widthwise direction of the vehicle, and these end portions are fixed to opposite side members, not shown, of the vehicle body. A brake booster 54 for increasing the foot power of the driver is fixed to a portion of the dash panel 50 which is located on an engine-compartment side of the dash panel 50. A push rod 56 of the brake booster 54 extends rearward through the dash panel 50, and a rear end of the push rod 56 is coupled to the arm 40 of the pedal 20. That is, when the pedal 20 is moved or swung frontward by the foot power of the driver, the push rod 56 is moved frontward, causing the brake booster 54 to increase the foot power of the driver. The increased foot power is converted into hydraulic pressure by a master cylinder, not shown, and transferred to brake cylinders respectively corresponding to wheels.

The present brake operating device 10 includes a first return spring 70 and a second return spring 72. The first return spring 70 is provided between the pedal 20 and a rear end portion of the pedal support 22, specifically, between the arm 40 of the pedal 20 and the bracket 30 of the pedal support 22. The first return spring 70 is an extension coil spring which is extended with depression of the pedal 20 and urges the pedal 20 in a direction in which the pedal 20 is returned to a neutral position. That is, the first return spring 70 serves as a first spring which is extended with forward movement of the pedal 20 to urge the pedal 20 in a direction in which the pedal 20 is moved backward.

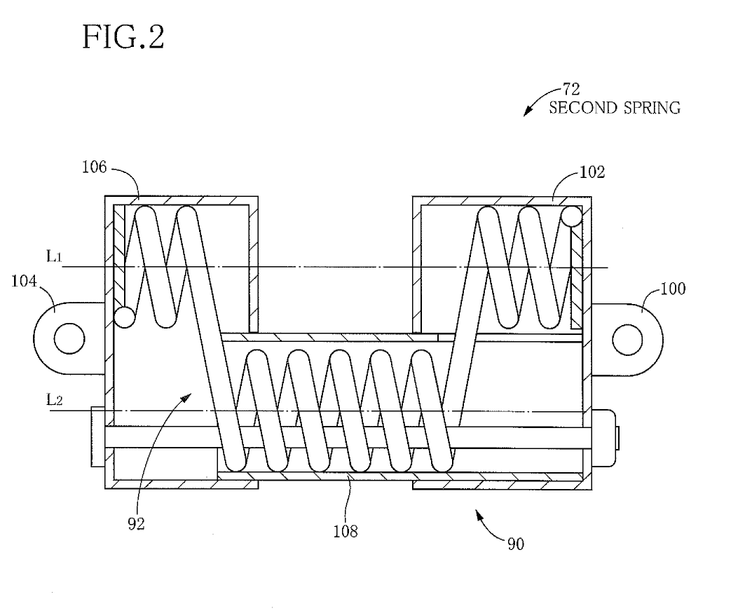

The second return spring 72 is provided between the pedal 20 and a front end portion of the pedal support 22, specifically, between the arm 40 of the pedal 20 and the base 24 of the pedal support 22. As illustrated in FIG. 2, the second return spring 72 includes a housing 90 and a buckling spring 92 accommodated in the housing 90. The buckling spring 92 is compressed by a member extending through the buckling spring 92 in the state in which the buckling spring 92 is accommodated in the housing 90. In this state, the buckling spring 92 has the length illustrated in FIG. 2. The buckling spring 92 buckles when compressed by a particular length. The buckling spring 92 has a front end 94, a rear end 96, and an intermediate portion 98 shaped like a coil. The buckling spring 92 is constructed such that an axis L₂ of the intermediate portion 98 does not coincide with an axis L₁ extending through the front end 94 and the rear end 96. That is, the axis L₂ extends at a position displaced from the axis L₁ in a direction perpendicular to a direction in which the axis L₁ extends, and the axis L₂ extends in a direction parallel to the direction in which the axis L₁ extends. This construction facilitates buckling of the buckling spring 92.

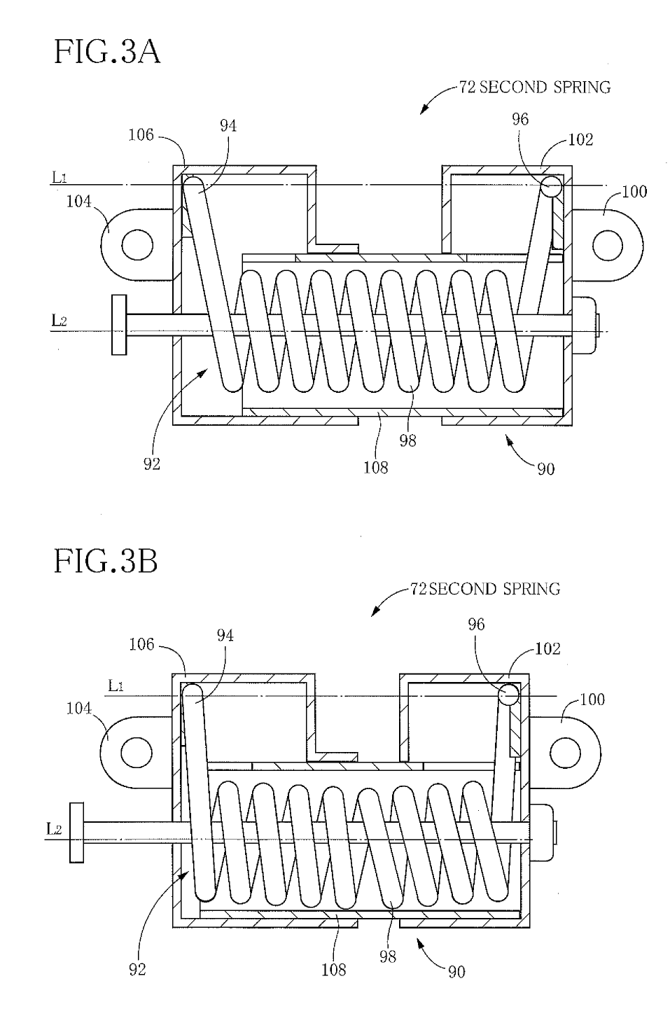

The housing 90 has a generally three-sided rectangular shape which opens upward in side view such that the buckling spring 92 having the above-described shape is disposed within the housing 90. Specifically, the housing 90 includes: a pedal-side member 102 provided with a coupling portion 100 coupled to the pedal 20; a support-side member 106 provided with a coupling portion 104 coupled to the pedal support 22; and an intermediate member 108 connecting between the pedal-side member 102 and the support-side member 106. The intermediate member 108 is fixed to the pedal-side member 102 so as to extend from a lower portion of a front surface of the pedal-side member 102. The support-side member 106 is mounted on the intermediate member 108 so as to be slidable in an axial direction of the intermediate member 108. That is, the pedal-side member 102 and the support-side member 106 can be brought closer to each other. In other words, the housing 90 can be contracted. It is noted that, as illustrated in FIGS. 3A and 3B, the direction in which the axis L₂ of the intermediate portion 98 extends is parallel to the direction in which the axis of the intermediate member 108 extends in the state in which the buckling spring 92 is accommodated in the housing 90.

Accordingly, when the pedal 20 is depressed, the housing 90 is contracted, whereby the second return spring 72 generates an elastic force by compression of the buckling spring 92 provided in the housing 90. That is, the second return spring 72 is compressed with depression of the pedal 20 and urges the pedal 20 in a direction in which the pedal 20 is returned to the neutral position. That is, the second return spring 72 serves as a second spring which is compressed with forward movement of the pedal 20 to urge the pedal 20 in the direction in which the pedal 20 is moved backward.

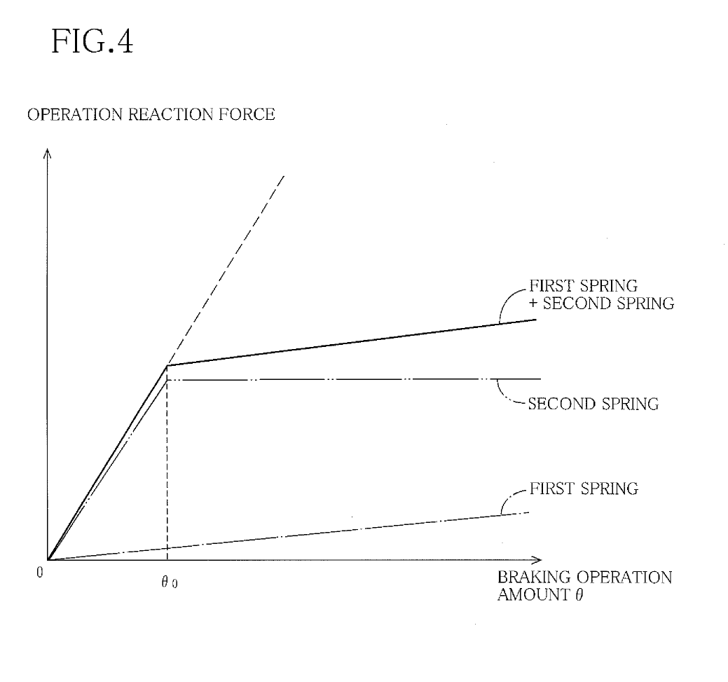

As described above, the buckling spring 92 starts buckling when compressed to a state illustrated in FIG. 3A by depression of the pedal 20 by a predetermined angle θ₀ from the neutral position of the pedal 20. Specifically, in addition to the compression force acting on the buckling spring 92, a force acting on the buckling spring 92 is generated and to be directed in a direction intersecting the axis L₂ at the intermediate portion 98. More specifically, the force acting on the buckling spring 92 is to be directed downward in FIGS. 3A and 3B. That is, when the buckling spring 92 is further compressed from the state illustrated in FIG. 3A by further depression of the pedal 20 by an angle greater than the predetermined angle θ₀, as illustrated in FIG. 3B, the buckling spring 92 is bent such that a central portion of the intermediate portion 98 is moved downward. Also, the intermediate portion 98 is offset from the front end 94 and the rear end 96. Thus, also when the front end 94 and the rear end 96 are brought further closer to each other after the occurrence of the buckling, the buckling spring 92 is deformed between the front end 94 and the intermediate portion 98 and between the rear end 96 and the intermediate portion 98. With these constructions, as illustrated in FIG. 4, the buckling spring 92 has a characteristic in which after a braking operation amount θ becomes equal to the predetermined angle θ₀ and the buckling occurs (that is, the braking operation amount θ becomes greater than the predetermined angle θ₀), the elastic force generated by the buckling spring 92 does not increase from the occurrence of the buckling even when the pedal 20 is further depressed. In this brake operating device 10, accordingly, only the elastic force of the first return spring 70 increases in the state of buckling of the buckling spring 92. It is noted that a spring constant K₁ of the first return spring 70 is much smaller than a spring constant K₂ of the second return spring 72 before its buckling. When the second return spring 72 buckles, an increase in operation reaction force against the braking operation depends only upon increase in the elastic force of the first return spring 70. As illustrated in FIG. 4, the increase in operation reaction force against the braking operation is considerably smaller after the buckling of the second return spring 72 than before the buckling (that is, the braking operation amount θ is less than the predetermined angle θ₀).

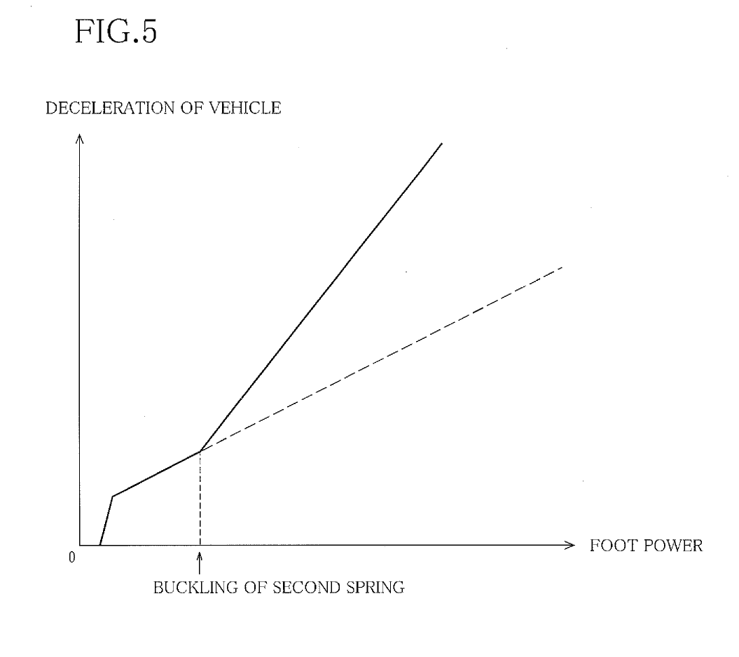

Accordingly, in the brake operating device 10 according to the present embodiment, the two return springs 70, 72 apply a relatively large reaction force to the pedal 20 at initial brake input to the pedal 20, resulting in generation of a feeling of stiffness. In the case where the braking operation amount increases due to, sudden braking, as illustrated in FIG. 5, the second return spring 72 buckles, and an increase in the reaction force decreases with respect to an increase in the operation amount. Accordingly, the operating amount easily increases with respect to the braking operation, enabling generation of a large braking force.

As illustrated in FIG. 4, the brake operating device 10 according to the present embodiment is constructed such that, after the buckling, the elastic force of the second return spring 72 does not increase even when the braking operation amount is increased. However, the characteristic of the second spring is not limited to this characteristic. For example, the second spring may have a characteristic in which even when the elastic force increases with further increase in the braking operation amount after the occurrence of the buckling, an amount of increase in the elastic force with respect to the braking operation amount is smaller than that before the buckling. Also, the second spring may have a characteristic in which the elastic force is smaller after the occurrence of the buckling than before the occurrence of the budding, for example. In this construction, in the case where the brake operating device is constructed such that an operation reaction force of both of the first spring and the second spring is smaller after the occurrence of the buckling of the second spring than before the occurrence of the buckling of the second spring, the reaction force with respect to the braking operation increases also after the occurrence of the buckling of the second spring, making it possible to provide an operation feeling for the driver.

What is claimed is:

1. A brake operating device, comprising:
a brake operating member configured to be operated and moved forward;
a first spring configured to be extended with forward movement of the brake operating member to urge the brake operating member in a direction in which the brake operating member is moved backward; and
a second spring configured to be compressed with forward movement of the brake operating member to urge the brake operating member in the direction in which the brake operating member is moved backward,
the second spring configured to buckle when the brake operating member is moved by greater than or equal to a predetermined amount.

2. The brake operating device according to claim 1,
wherein the brake operating member is a brake pedal comprising a lower end portion provided with a depressing portion,
wherein the brake operating device comprises a pedal support configured to support the brake pedal at an upper portion of the brake pedal such that the brake pedal is pivotable, and
wherein the second spring is configured to buckle when the brake pedal is depressed by greater than or equal to a predetermined angle.

3. The brake operating device according to claim 2,
wherein the first spring is provided between the brake pedal and a rear portion of the pedal support, and
wherein the second spring is provided between the brake pedal and a front portion of the pedal support.

4. The brake operating device according to claim 1, wherein a spring constant of the second spring before buckling of the second spring is greater than a spring constant of the first spring.

5. The brake operating device according to claim 1,
wherein the first spring and the second spring are configured to urge the brake operating member by a total force in the direction in which the brake operating member is moved backward, and
wherein an amount of increase in the total force with respect to a distance of forward movement of the brake operating member is less after an occurrence of buckling of the second spring than before the occurrence of the buckling of the second spring.

6. The brake operating device according to claim 1, wherein the second spring is configured such that a force of the second spring for urging the brake operating member in the direction in which the brake operating member is moved backward does not increase even when the brake operating member is further moved forward after an occurrence of buckling of the second spring.

7. The brake operating device according to claim 1, wherein the second spring is a compression coil spring comprising a front portion, a rear portion, and an intermediate portion between the front portion and the rear portion of the compression coil spring and shaped such that a straight line connecting between the front portion and the rear portion and an axis of the intermediate portion are displaced from each other.
